(19) United States
(12) Patent Application Publication
(10) Pub. No.: US 2010/0039080 A1
(43) Pub. Date: Feb. 18, 2010

(54) Single-inductor buck-boost converter with positive and negative outputs

(75) Inventors: Steve Schoenbauer, Colorado Springs, CO (US); Fernando R. Martin-Lopez, Colorado Springs, CO (US)

Correspondence Address: WILLIAM E HEIN, PO BOX 335, LOVELAND, CO, 80539-0335, US

(73) Assignee: Toko, Inc.

(21) Appl. No.: 12/228,310

(22) Filed: Aug. 12, 2008

(51) Int. Cl. G05F 1/10

(52) U.S. Cl. 323/234

(57) ABSTRACT

A single-inductor power converter with buck-boost capability provides regulated bipolar output voltage to a positive and a negative load. A five-switch bridge topology allows a controller to direct the inductor current to the appropriate outputs or circuit ground as needed to maintain regulation. The controller also adjusts the inductor current level for proper output voltage regulation. The five-switch bridge topology makes possible a wide range of ratios between the positive and negative output currents of the converter.

### BACKGROUND AND SUMMARY OF THE INVENTION

This invention relates to single-inductor switch-mode power conversion circuit topologies which function to produce bipolar outputs of positive and negative polarity. This class of power converters is sometimes referred to as SI-MO (Single-Inductor, Multiple-Output).

Several types of power converters are known in the prior art, the most common type being the Single-Inductor, Multiple-Input, Multiple-Output (SI-MIMO) power converter. U.S. Pat. No. 7,256,568 describes a step-down or buck converter in which the input-side and output-side switches are used for the dual purposes of time-multiplexing various input sources and output loads and performance of the buck mode of operation. Additionally, U.S. Pat. Nos. 6,222,352; 7,061,214; and 7,224,085 are directed to various SI-MO buck converters. However, unlike the preset invention, the circuit topologies and switch sequence operations described in the prior art do not provide buck-boost capability with the generation of bipolar output voltages.

U.S. Patent Application No. 2004/0201281 A1 describes a group of switch-mode converter topologies which employ the Pseudo Continuous Conduction Mode (PCCM) of operation in which a switch selectively shunts the inductor. By contrast, the present invention operates in either Discontinuous Conduction Mode (DCM) or Continuous Conduction Mode (CCM), as required by load current conditions, without use of the PCCM technique. The foregoing acronyms are commonly used in the art, as set forth by Erickson & Maksimovic, Fundamentals of Power Electronics, 2^{nd} Ed., Kluwer Academic Publishers, 2001.

U.S. Pat. No. 6,075,295 describes a SI-MO boost type power converter. However, like other known power converters, this power converter does not provide the buck-boost or bipolar voltage output capabilities of the present invention.

Finally, U.S. Pat. No. 5,617,015 describes SI-MO buck, buck-boost, and SEPIC switch-mode converters, but using a comparator-controlled, threshold-activated hysteretical regulation control technique. This is unlike the power converter of the present invention, which develops proportional continuous control signals by evaluating error feedback levels.

In the design of portable electronic products, such as mobile communications gear, there is a need for low-cost, efficient, and physically compact power conversion circuits. For example, the required positive and negative voltages powering a cell phone's active-matrix organic LED display driver are sometimes generated using a two-inductor switch-mode power supply. Since inductors tend to be relatively large and represent additional cost, a single-inductor approach which produces bipolar outputs would be attractive. In accordance with the present invention, a single-inductor switch-mode converter produces bipolar output voltages and is capable of buck-boost operation to either step up or step down the input source voltage.

The power converter of the present invention employs a single inductor and produces two output voltages of opposite polarity with respect to ground from a single input supply voltage. Its buck-boost capability permits the output voltages to be either higher or lower than the input supply voltage source and to be independently adjustable by means of feedback component selection. These important features are accomplished through the use of a five-switch bridge. Two of the switches are capable of steering inductor current to ground which, under direction from a controller, allows inductor current to be diverted away from either output as needed to maintain proper output voltage regulation. In the preferred embodiment, the inductor current can be delivered to both outputs during a single switching cycle. The result is a lower output voltage ripple compared to prior art power converters which steer pulses of inductor current to an output terminal on alternating switch cycles.

The five-switch configuration of the present power converter relieves constraints on the ratio of the output currents delivered by the single inductor to the positive and negative output terminals over a wide range of input voltages. By contrast, the prior art four-switch power converters are subject to those constraints.

### BRIEF DESCRIPTION OF THE DRAWINGS

FIG. 1 is a schematic diagram of a single-inductor, dual output (bi-polar) power converter in accordance with the present invention.

FIG. 2 is a detailed block diagram of one embodiment of the controller employed in the power converter of FIG. 1.

FIG. 3 is a set of timing diagrams illustrating operation of the five-switch bridge of the power converter of FIG. 1 for a first set of output currents.

FIG. 4 is a set of timing diagrams illustrating operation of the five-switch bridge of the power converter of FIG. 1 for a second set of output currents.

FIG. 5 is a set of timing diagrams illustrating operation of the five-switch bridge of the power converter of FIG. 1 for a third set of output currents.

### DESCRIPTION OF THE PREFERRED EMBODIMENT

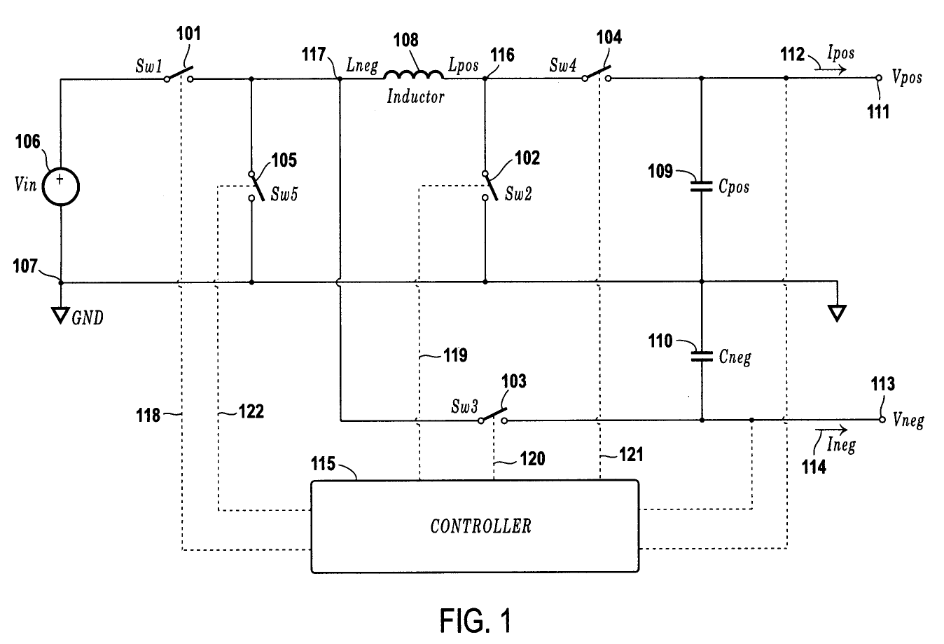

Referring now to FIG. 1, there is shown a buck-boost SI-MO power converter circuit in accordance with the present invention that employs a single inductor and a five-switch bridge. The circuit utilizes a single source of supply voltage 106 to produce positive and negative output voltages at output terminals 111, 113, with respect to circuit ground terminal 107. An input switch 101 connects the supply voltage 106 to a first terminal 117 of an inductor 108. A switch 105 is connected between terminal 117 of inductor 108 and ground terminal 107. A switch 103 is connected between terminal 117 of inductor 108 and a negative output terminal 113. A switch 102 is connected between a second terminal 116 of inductor 108 and ground terminal 107. A switch 104 is connected between terminal 116 of inductor 108 and a positive output terminal 111. Switches 103, 104 may be replaced by conventional diode devices. A first capacitor 109 is connected between positive output terminal 111 and ground terminal 107. A second capacitor 110 is connected between negative output terminal 113 and ground terminal 107. Capacitors 109, 110 serve to maintain the voltage at output terminals 111, 113 by supplying load current during the time that inductor 108 is disconnected from a load at output terminals 111, 113.

A controller 115 may utilize any of a number of control techniques, such as CPM, DPM or PFM, as detailed below, and may employ an error amplifier and pulse width modulator (PWM) sub-blocks, all of which may be selected and configured by persons having ordinary skill in the art. Controller 115 serves to provide independent activation of all five switches 101, 102, 103, 104, 105 via signal lines 118, 119, 120, 121, 122 and to organize the charge and discharge cycles of current flowing through inductor 108. By sensing the voltages at output terminals 111, 113, controller 115 serves to activate the appropriate ones of switches 101, 102, 103, 104, 105 to direct the currents at terminals 116, 117 of inductor 108 either to the respective output terminals 111, 113 or to ground terminal 107, as required to maintain proper output voltage regulation. The voltage regulation set-points maintained by controller 115 at output terminals 111, 113 are established by means of conventional feedback loop elements internal to controller 115 that serve to sense the output voltages at output terminals 111, 113 and compare each of them to a reference voltage to produce a feedback error signal. Controller 115 then processes the feedback error signal to produce a control signal which, when applied to conventional circuitry, acts to minimize the error signal. For example, those skilled in the art will recognize that sensing the output voltages may be accomplished using passive component voltage dividers employing resistors and/or capacitors such that, in conjunction with the reference voltage, an error amplifier, compensator, and pulse width modulator, an output voltage regulation set-point can be established. By varying the sensing component ratio and/or reference voltages, the positive and negative output voltage regulation set-points can be adjusted independently of each other to produce output voltages at output terminals 111, 113 that differ in magnitude from each other, if so desired.

In addition, activation of the five switches 101, 102, 103, 104, 105 by controller 115 may be dependent on achieving a proper duty ratio or pulse width as required in the conventional duty programmed mode (DPM) of operation of power converters. Alternatively, activation of switches 101, 102 by controller 115 may be dependent on setting a desired current through inductor 108 by using the conventional current programmed mode (CPM) of power converter operation. CPM includes both the conventional peak current and valley current methods, in which the inductor 108 current ramp is started or terminated if it passes above or below a threshold value set by sensing the voltage at output terminals 111, 113. Additionally, rather than employing a constant period switching cycle as in CPM or DPM, controller 115 may employ a conventionally-implemented pulse frequency mode (PFM) for controlling the current flow through inductor 108 under light load conditions in order to improve converter efficiency. The conventional details of operation of CPM, DPM, and PFM power converters, including the use of voltage dividers, reference voltages, error amplifiers, compensators, pulse width modulators, etc., required to implement each of these power converter modes, may be readily understood with reference to the Erickson & Macksimovic text cited above.

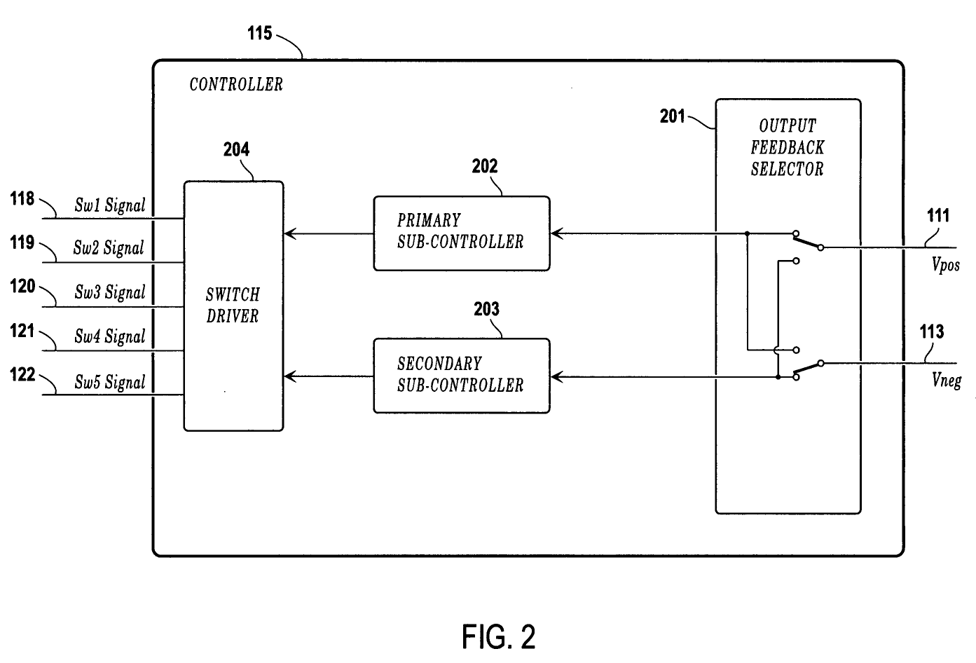

In the embodiment of controller 115 illustrated in FIG. 2, a primary sub-controller 202 and a secondary sub-controller 203, of the conventional types described above, operate simultaneously and in conjunction with an output feedback selector block 201 and a switch driver block 204. In this arrangement, the feedback selector block 201 directs the feedback signal to primary sub-controller 202 from a first one of output terminals 111, 113 that is delivering the larger of load currents 112, 114 illustrated in FIG. 1. Primary sub-controller 202 utilizes the feedback signal to adjust the current charging cycle of inductor 108 via switch driver block 204 to meet that greater load current requirement and to thereby regulate the voltage at the first one of output terminals 111, 113. In a similar manner, feedback selector block 201 also directs the feedback signal to secondary sub-controller 203 from the other one of output terminals 111, 113 that is delivering the smaller of load currents 112, 114. Secondary sub-controller 203 utilizes this feedback signal to control the appropriate one of switches 101, 102, 103, 104, 105 via switch driver 204 to divert some of the current flowing through inductor 108 away from the other one of output terminals 111, 113 to thereby regulate the output voltage at that other output terminal. Other conventional techniques may be employed by controller 115 for controlling the power converter circuit of FIG. 1.

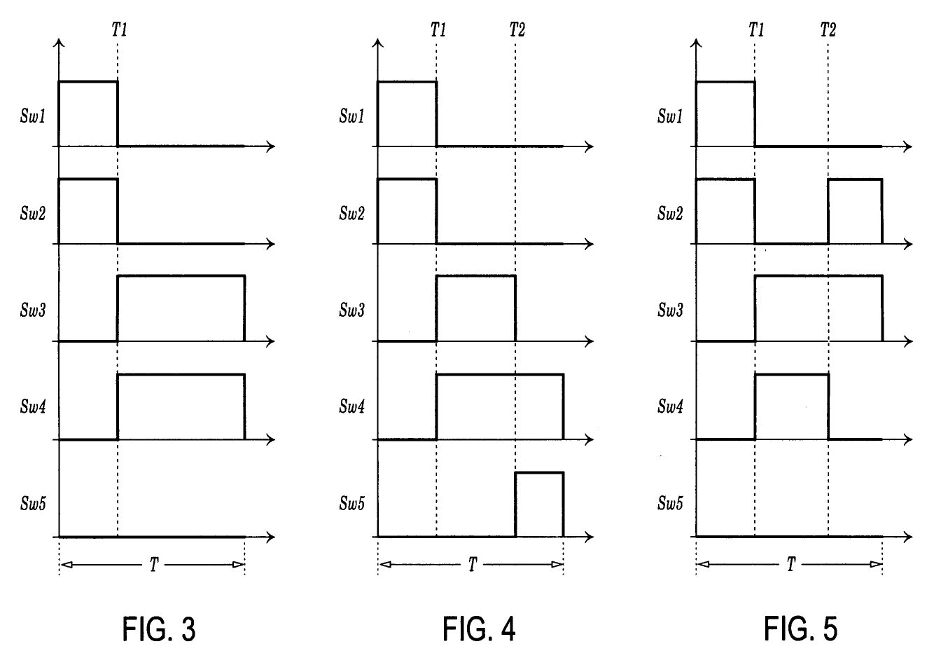

Operation of the five-switch bridge of the power converter circuit of FIG. 1 in the constant-period PWM mode may be understood with reference to the timing diagrams of FIGS. 3-5. In these diagrams, the closed or open state of each of the switches 101, 102, 103, 104, 105 during one complete switching cycle of time duration T is indicated, with the closed state of a particular switch denoted by an elevated horizontal line on each timing diagram.

Since both of the output terminals 111, 113 are fed by the current flowing through the single inductor 108, a critical factor in the operation and control of the converter switching involves the relative matching of current 112 flowing out of positive output terminal 111 with the current 114 flowing into negative output terminal 113. In particular, output voltages on capacitors 109, 110 could experience pump-up or decay due to excessive or inadequate current delivery to the respective one of output terminals 111, 113. In this regard, three cases of output current matching and associated switch activation are considered. The case in which output current 112 is equal to output current 114 is illustrated by the timing diagrams of FIG. 3. The case in which output current 112 is greater than output current 114 is illustrated by the timing diagrams of FIG. 4. The case in which output current 114 is greater than output current 112 is illustrated by the timing diagrams of FIG. 5.

Referring now to FIG. 3, illustrating the switch timing in the case in which output current 112 is equal to output current 114, it may be seen that from the beginning of the cycle until time T1, closure of switches Sw 1 and Sw 2 serves to apply the source voltage 106 to inductor 108, thus building current and increasing energy storage in inductor 108. From time T1 to the end of the cycle duration T, it is possible to deliver equal average currents to both positive and negative output terminals 111, 113 by connecting each of the inductor terminals 116, 117 to the respective one of output terminals 111, 113, thus satisfying the assumption that output current 112 is equal to output current 114. Controller 115 accomplishes this by opening switches 101 and 102 and then closing switches 103 and 104 for the remainder of the cycle.

Referring now to FIG. 4, illustrating the switch timing in the case in which output current 112 is greater than output current 114, it may be seen that from the beginning of the cycle until time T2, all of the switches Sw 1-Sw 5 are controlled as described in the preceding paragraph. At time T2, controller 115 opens switch Sw 3 and closes switch Sw 5. Terminal 117 of inductor 108 that formerly delivered current to output terminal 113 now delivers current to ground terminal 107 through switch 105. The time period between time T2 and the end of the cycle is referred to as the second portion of the inductor discharge cycle. This switch state continues for the remainder of the cycle to ensure that the average current delivered at output terminal 113 is sufficient to maintain the output voltage at that terminal at the equilibrium level of the negative output feedback loop.

Referring now to FIG. 5, illustrating the switch timing in the case in which output current 114 is greater than output current 112, it may be seen that from the beginning of the cycle until time T2, all of the switches Sw 1-Sw 5 are controlled as illustrated in FIGS. 3 and 4. The time period between times T1 and T2 is referred to as the first portion of the inductor discharge cycle. At time T2, controller 115 opens switch Sw 4 and closes switch Sw 2. Terminal 116 of inductor 108 that formerly delivered current to output terminal 114 now delivers current to ground terminal 107 through switch 102. The time period between time T2 and the end of the cycle is referred to as the second portion of the inductor discharge cycle. This switch state continues for the remainder of the cycle to ensure that the average current delivered at output terminal 111 is sufficient to maintain the output voltage at that terminal at the equilibrium level of the positive output feedback loop.

We claim:

1. A buck-boost power converter for producing positive and negative output voltages of the same magnitude at positive and negative output terminals, the power converter comprising:
a source of DC supply voltage;
a single inductor having first and second terminals;
a switch network comprising a plurality of switch elements for switching a current flowing in said inductor between a selected one of said positive and negative output terminals and a ground terminal; and
controller means coupled to said plurality of switch elements and to said positive and negative output terminals for selectively closing and opening said plurality of switch elements to produce positive and negative regulated DC output voltages of selected pre-set magnitudes at said positive and negative output terminals, respectively, said positive and negative output voltages being selectively stepped up or stepped down from said DC supply voltage.

2. A power converter as in claim 1, further comprising:
a first voltage-maintaining capacitor connected between said positive output terminal and said ground terminal; and
a second voltage-maintaining capacitor connected between said negative output terminal and said ground terminal.

3. A power converter as in claim 1, wherein said plurality of switch elements comprise:
a first switch element connected between said first terminal of said inductor and said source of DC supply voltage;
a second switch element connected between said second terminal of said inductor and said ground terminal;
a third switch element connected between said first terminal of said inductor and said negative output terminal;
a fourth switch element connected between said second terminal of said inductor and said positive output terminal; and
a fifth switch element connected between said first terminal of said inductor and said ground terminal.

4. A power converter as in claim 3, wherein said third and fourth switch elements comprise diode devices.

5. A power converter as in claim 1, wherein said controller means is operative for sensing said positive and negative output voltages at said positive and negative output terminals and for controlling a duty ratio of said switch elements in response to said sensed positive and negative output voltages.

6. A power converter as in claim 1, wherein said controller means is operative for sensing said positive and negative output voltages at said positive and negative output terminals and for controlling a pulse frequency of said switch elements in response to said sensed positive and negative output voltages.

7. A power converter as in claim 1, wherein said controller means comprises one or more pulse width modulation circuits for producing pulses whose widths vary with said positive and negative output voltages.

8. A power converter as in claim 1, wherein said controller means comprises a selected one or more peak and valley inductor current threshold detection circuits having activation levels that vary with said positive and negative output voltages.

9. A power converter as in claim 5, wherein said controller means is operative, during a first portion of a discharge cycle of said inductor, for controlling said plurality of switch elements to deliver positive and negative currents, respectively, flowing in said inductor, to a selected one of the following node combinations: (a) both of said positive and negative output terminals; (b) said positive output terminal and said ground terminal; (c) said ground terminal and said negative output terminal.

10. A power converter as in claim 9, wherein said controller means is operative, during a second portion of said discharge cycle of said inductor, for controlling said plurality of switch elements to deliver positive and negative currents, respectively, flowing in said inductor, to a selected different one of said node combinations than was selected during said first portion of said discharge cycle of said inductor.

11. A power converter as in claim 9, wherein said first and second portions of said discharge cycle of said inductor occur during a same switching period.

12. A power converter as in claim 10, wherein said first and second portions of said discharge cycle of said inductor occur during a same switching period.

13. A power converter as in claim 9, wherein the selection of said one of said node combinations is based upon sensing a selected one or both of said positive and negative output voltages.

14. A power converter as in claim 10, wherein the selection of said different one of said node combinations is based upon sensing a selected one or both of said positive and negative output voltages.
